(19) United States
(12) Patent Application Publication
(10) Pub. No.: US 2008/0198096 A1
(43) Pub. Date: Aug. 21, 2008

(54) Dual Monitor

(76) Inventor: Woo-Chong Jung, Seoul (KR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/737,996

(22) Filed: Apr. 20, 2007

(30) Foreign Application Priority Data
Feb. 20, 2007 (KR) 2007-17041

(51) Int. Cl. G09G 5/00

(52) U.S. Cl. 345/1.3

(57) ABSTRACT

A dual monitor includes a first monitor, a second monitor and a connecting member. The first monitor includes a first screen heading for a first direction. The second monitor includes a second screen heading for substantially same as the first direction for which the first screen heads, and being fixed on a rear surface of the first monitor on which the first screen is not disposed. The connecting member connects the first monitor with the second monitor, and disposes the second monitor near one side portion of the first monitor when the second monitor is used. Therefore, two monitors fixed to each other may be simultaneously used to enhance efficiency of work, and two monitors fixed to each other may be safely moved to enhance convenience.

### CROSS-REFERENCE TO RELATED APPLICATIONS

This application claims priority under 35 U.S.C. § 119 to Korean Patent Application No. 2007-17041, filed on Feb. 20, 2007, in the Korean Intellectual Property Office (KIPO), the contents of which are herein incorporated by reference in their entirety.

### BACKGROUND OF THE INVENTION

1. Field of the Invention

The present invention relates to a dual monitor. More particularly, the present invention relates to the dual monitor capable of being used at the same time and being safely moved at the same time.

2. Description of the Related Art

Recently, according as a method for manufacturing a display apparatus is developed, a display panel used for a monitor becomes to have thinner thickness, lighter weight and smaller size. Thus, at least more than two monitors connected to one computer are often used to enhance efficiency of work in almost every office.

However, when the computer is moved or a movable computer such as a laptop is used, more than two monitors are hard to be safely moved. In addition, more than two monitors are hard to be set up and to be used while the computer is on the move. Thus, the efficiency of work may be decreased when the computer is used on the move.

To solve above problem, the monitor including two monitors combined with each other is developed. For example, two monitors fold to face each other like a mobile phone. However, when two monitors just fold to face each other, each monitor is exposed to outside, so that two monitors are hard to be safely protected.

### SUMMARY OF THE INVENTION

The present invention provides a dual monitor combined with each other via various combination methods.

In an example dual monitor to the present invention, the dual monitor includes a first monitor, a second monitor and a connecting member. The first monitor includes a first screen heading for a first direction. The second monitor includes a second screen heading for substantially same as the first direction for which the first screen heads, and being fixed on a rear surface of the first monitor on which the first screen is not disposed. The connecting member connects the first monitor with the second monitor, and disposes the second monitor near one side portion of the first monitor when the second monitor is used.

The connecting member includes a guide fixing member fixed on the rear surface of the first monitor, and including a cover portion and a guide line, the cover portion having four side surfaces width of which corresponds to that of the second monitor and at least one of which is open for the second monitor to pass through, the guide line being disposed on an inner surface of the side surface perpendicular to the opened side surface to guide the second monitor, and a guide bar including a slider that is disposed at least one end portion of the guide bar and is guided by the guide line, and a guide protrusion that is disposed at a central portion of the guide bar along a second direction substantially perpendicular to the first direction.

In another example dual monitor according to the present invention, the dual monitor includes a first monitor, a second monitor and a connecting member. The first monitor includes a first screen heading for a first direction. The second monitor includes a second screen heading for substantially opposite direction to the first direction for which the first screen heads and being fixed on a rear surface of the first monitor on which the first screen is not disposed. The second monitor rotates with respect to a protrusion formed on a side surface of the second monitor to head for substantially same as the first direction. The connecting member connects the first monitor with the second monitor, and disposes the second monitor near one side portion of the first monitor when the second monitor is used.

The connecting member includes a guide fixing member fixed on the rear surface of the first monitor, and including a cover portion and a guide line, the cover portion having four side surfaces width of which corresponds to that of the second monitor and at least one of which is open for the second monitor to pass through, the guide line being disposed on an inner surface of the side surface perpendicular to the opened side surface to guide the second monitor, and a guide bar including a slider that is disposed at least one end portion of the guide bar and is guided by the guide line, and a guide protrusion that is disposed at a central portion of the guide bar along a second direction substantially perpendicular to the first direction.

In still another example dual monitor according to the present invention, the dual monitor includes a first monitor, a second monitor and a connecting member. The first monitor includes a first screen heading for a first direction, and a rear protrusion formed at a side central portion of a rear surface of the first monitor on which the first screen is not disposed along substantially opposite direction to the first direction. The second monitor includes a second screen heading for substantially same as the first direction for which the first screen heads, and being fixed on the rear surface of the first monitor on which the first screen is not disposed. The connecting member connects the first monitor with the second monitor, and disposes the second monitor near one side portion of the first monitor when the second monitor is used.

The connecting member includes a first rotation part having a first connecting groove formed at a central portion of the first rotation part and a first connecting protrusion formed substantially perpendicular to the first connecting groove, the rear protrusion inserted into the first connecting groove.

In still another example dual monitor according to the present invention, the dual monitor includes a first monitor, a second monitor and a connecting member. The first monitor includes a first screen heading for a first direction, and a rear protrusion formed at a side central portion of a rear surface of the first monitor on which the first screen is not disposed along substantially opposite direction to the first direction. The second monitor includes a second screen heading for substantially opposite to the first direction for which the first screen heads and being fixed on the rear surface of the first monitor on which the first screen is not disposed. The second monitor rotates with respect to a protrusion formed on a side surface of the second monitor to head for substantially same as the first direction. The connecting member connects the first monitor with the second monitor, and disposes the second monitor near one side portion of the first monitor when the second monitor is used.

The connecting member includes a first rotation part having a first connecting groove formed at a central portion of the first rotation part and a first connecting protrusion formed substantially perpendicular to the first connecting groove, the rear protrusion inserted into the first connecting groove, and the first rotation part rotates with respect to the rear protrusion.

In still another example dual monitor according to the present invention, the dual monitor includes a first monitor, a second monitor and a connecting member. The first monitor includes a first screen heading for a first direction, and a side protrusion formed substantially perpendicular to the first direction at a central portion of a side surface of the first monitor. The second monitor includes a second screen heading for substantially same as the first direction for which the first screen heads, and being fixed on the rear surface of the first monitor on which the first screen is not disposed. The connecting member connects the first monitor with the second monitor, and disposes the second monitor near one side portion of the first monitor when the second monitor is used.

The connecting member includes a first rotation part having a first connecting groove formed at a central portion of the first rotation part and a first connecting protrusion formed along substantially opposite direction to the first connecting groove, the side protrusion inserted into the first connecting groove.

In still another example dual monitor according to the present invention, the dual monitor includes a first monitor, a second monitor and a connecting member. The first monitor includes a first screen heading for a first direction, and a side protrusion formed substantially perpendicular to the first direction at a central portion of a side surface of the first monitor. The second monitor includes a second screen heading for substantially opposite direction to the first direction for which the first screen heads and being fixed on the rear surface of the first monitor on which the first screen is not disposed. The second monitor rotates with respect to a protrusion formed on a side surface of the second monitor to head for substantially same as the first direction. The connecting member connects the first monitor with the second monitor, and disposes the second monitor near one side portion of the first monitor when the second monitor is used.

According to the present invention, when the second monitor is not used, the first and second monitors are overlapped with each other to head for substantially same direction, so that the second screen may be protected without using additional protective elements.

In addition, when the second monitor is used, the second monitor is easily disposed near one side portion of the first monitor, to enhance efficiency of work.

In addition, the fixing member fixes the second monitor, so that the connecting member connecting the first monitor with the second monitor may be prevented from being bent or being damaged.

### BRIEF DESCRIPTION OF THE DRAWINGS

The above and other features and advantages of the present invention will become more apparent by describing in detailed example embodiments thereof with Reference to the accompanying drawings, in which:

FIG. 1 is an enlarged perspective view illustrating a dual monitor according to a first example embodiment of the present invention;

FIG. 2 is a cross-sectional view taken along a line I-I′ of FIG. 1;

FIG. 3 is a plan view illustrating a movement of a connecting member according to an example embodiment of the dual monitor in FIG. 1;

FIG. 4 is a plan view illustrating a movement of a connecting member according to another example embodiment of the dual monitor;

FIG. 5 is an enlarged perspective view illustrating a dual monitor according to a second example embodiment of the present invention;

FIG. 6 is a plan view illustrating a movement of a first rotation part of the dual monitor in FIG. 5;

FIG. 7 is a plan view illustrating a movement of a second rotation part of the dual monitor in FIG. 5;

FIG. 8 is an enlarged perspective view illustrating a dual monitor according to a third example embodiment of the present invention; and

FIGS. 9A to 9D are plan views illustrating a movement of a connecting member of the dual monitor in FIG. 8.

### DESCRIPTION OF THE EMBODIMENTS

The invention is described more fully hereinafter with Reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with Reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with Reference to the accompanying drawings.

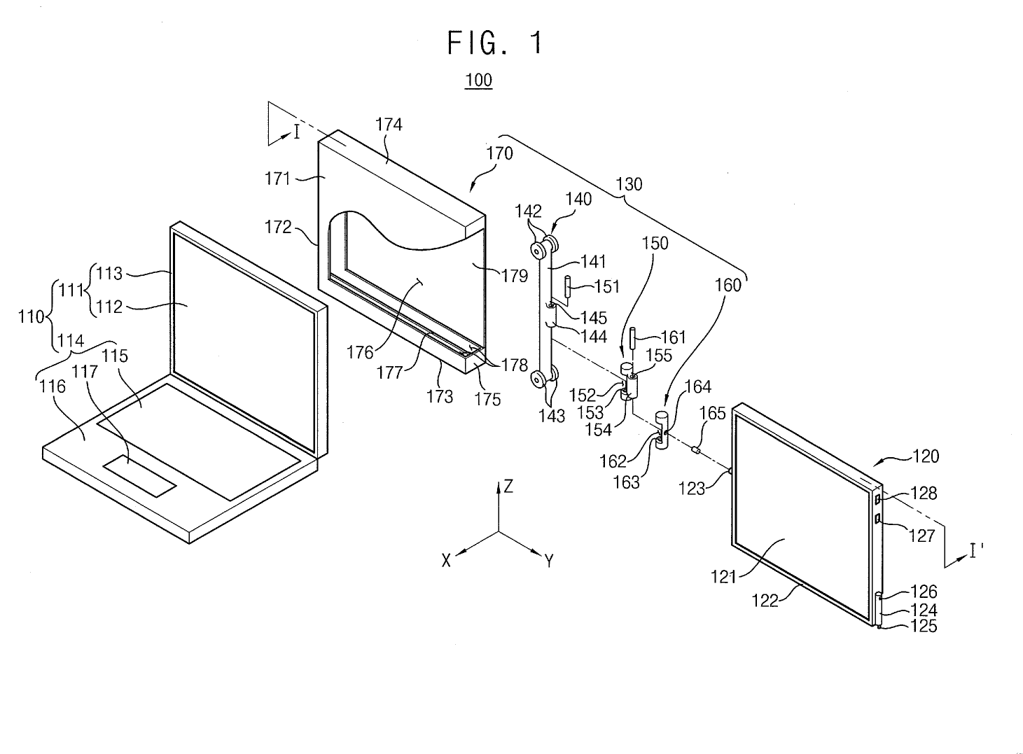

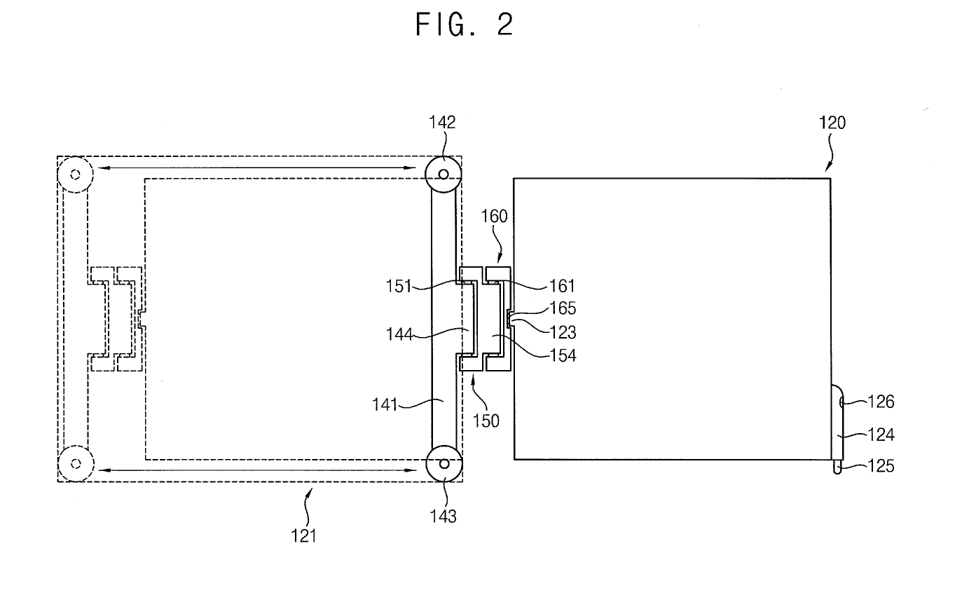

FIG. 1 is an enlarged perspective view illustrating a dual monitor 100 according to a first example embodiment of the present invention. FIG. 2 is a cross-sectional view taken along a line I-I′ of FIG. 1.

Referring to FIGS. 1 and 2, the dual monitor 100 according to the present example embodiment includes a first monitor 111, a second monitor 120 and a connecting member 130.

As illustrated in FIG. 1, when the dual monitor 100 is used in a laptop, the dual monitor 100 may further include a body 114 connected to the first monitor 111. The body 114 includes a base board 115 on which a keyboard is arranged, a supporting board 116 supporting hands, and a pad board on which a mouse pad is arranged. An upper portion of the body 114 is connected to a lower portion of the first monitor 111, and the first monitor 111 may be folded to face the body 114 with respect to the upper portion of the body 114. Alternatively, when the dual monitor 100 is used in a desktop, the dual monitor 100 may further include a supporting part (not shown) connected to the first monitor 111.

The first monitor 111 includes a first screen 112 displaying an image, and a first mold frame 113 enclosing a side surface and a rear surface of the first screen 112. In the present example embodiment, the first monitor 111 disposed substantially perpendicular to a ground will be explained. A first direction X is defined as a direction to which the first screen 112 displays the image, a second direction Y is defined substantially perpendicular to the first direction X, and a third direction Z is defined substantially perpendicular to the first and second directions X and Y at the same time.

Although not shown in the figure, the first monitor 111 may receive image information and control information through a terminal connected to a portion of a side surface of the first monitor 111.

The second monitor 120 includes a second screen 121, a second mold frame 122, a monitor protrusion 123 and a fixing member 125. The second screen 121 may display different or the same image as the first screen 112, and is fixed to head for substantially same direction as the first screen 112. For example, when the first screen 112 is fixed to head for the first direction X, the second monitor 121 may be fixed to head for the first direction X. However, when two monitors are used at the same time, the direction for which first screen 112 heads may be a little bit different from that for which the second screen 121 heads, for one's convenience.

The second mold frame 122 encloses a side surface and a rear surface of the second screen 121 to protect the second monitor 120.

The monitor protrusion 123 may be formed on all side surfaces of the second monitor, except a surface heading for a positive third direction +Z. When the monitor protrusion 123 is formed on the side surface heading for a positive second direction +Y or a negative second direction −Y, the second monitor 120 slides along the second direction Y. Alternatively, the monitor protrusion 123 is formed on the side surface heading for a negative third direction −Z, the second monitor 120 slides along the third direction.

The monitor protrusion 123 is preferably formed at a central portion of each side surface, and may be integrally formed with the second mold frame 122. Alternatively, the monitor protrusion 123 may be separately formed with the second mold frame 122, and then may be combined with the second mold frame 122.

The fixing member 125 is formed at an edge of a side surface of the second mold frame 122 on which the second screen 121 is not disposed. Particularly, when the monitor protrusion 123 is formed on the side surface heading for the negative second direction −Y, the fixing member 125 is formed at the edge of the side surface heading for the positive second direction +Y. Alternatively, when the monitor protrusion 123 is formed on the side surface heading for the positive second direction +Y, the fixing member 125 is formed at the edge of the side surface heading for the negative second direction −Y. In addition, when the monitor protrusion is formed on the side surface heading for the negative third direction −Z, the fixing member 125 may be omitted.

When the second monitor 120 is not used, the fixing member 125 is inserted into and is fixed to a fixing member cover portion 124. However, when the second monitor 120 is used, the fixing member 125 is protruded from the fixing member cover portion 124 by predetermined distance to reach a ground, so that the second monitor 120 is fixed to the ground. The fixing member 125 may have various shapes. Although not shown in the figure, an end portion of the fixing member 125 may be formed to have larger area to increase contact area with the ground.

When the second monitor 120 rotates with respect to a third connecting pin 165 that will be explained, the fixing member cover portion 124 and the fixing member 125 is fixed to rotate with respect to a rotation axis 126, so that the second monitor 120 may be fixed to the ground more safely. For example, although the second monitor 120 rotates by a predetermined angle, the fixing member cover portion 124 and the fixing member 125 rotates with respect to the rotation axis 126, to be always disposed perpendicular to the ground, so that the second monitor 120 may be fixed more safely.

The second monitor 120 may further include a monitor connecting terminal 127 formed on the side surface thereof to transmit or receive information data with the first monitor 111, and a power supplying terminal 128 formed on the side surface thereof to receive a power source.

The connecting member 130 according to the present example embodiment includes a guide fixing member 170 and a guide bar 140. The connecting member 130 may further include a first rotation part 150 and a second rotation part 160.

The guide fixing member 170 includes a cover portion and a guide line 177. Particularly, the cover portion includes a front cover portion 171 making contact with the rear surface of the first monitor 111, a rear cover portion 179 facing the front cover portion 171, and side cover portions 172, 173, 174 and 175 extending from the front cover portion 171 and the rear cover portion 179 to form a predetermined receiving space. The cover portion is fixed to the rear surface of the first monitor 111.

At least one side cover portion among the side cover portions 172, 173, 174 and 175 is open, so that the second monitor 120 passes through the opening portion. For example, as illustrate in FIG. 1, when the side cover portion 175 heading for the positive second direction +Y is open, the second monitor 120 may move to one side portion of the first monitor 111 through the opening portion. Alternatively, when the side cover portion 174 heading for the positive third direction +Z or the side cover portion 172 heading for the negative second direction −Y is open, the second monitor 120 may move to one side portion of the first monitor 111 through the opening portion. In addition, more than two side cover portions are open, so that the second monitor 120 may move to one side portion of the first monitor 111.

In this case, the side cover portions having the opening are formed to have a protrusion by a predetermined height. Thus, a slider 142 is fixed by the protrusion, so that the slider 142 may not get out of the guide fixing member 170. The side cover portions having the opening may further include an additional fixing member for the slider 142 not to get out of the guide fixing member 170.

The guide line 177 is disposed on an inner surface of at least one side surface perpendicular to the side cover portion having the opening. Particularly, as illustrated in FIG. 1, the guide line 177 is disposed on the inner surface of at least one side surface among the side cover portions 174 and 173 perpendicular to the side cover portion 175 having the opening. Alternatively, when the side cover portion 174 heading for the positive third direction +Z is open, the guide line 177 may be disposed on the inner surface of at least one side surface among the side cover portions 172 and 175 perpendicular to the side cover portion 174 having the opening.

The guide line 177 is protruded from the inner surface of the side cover portion by a predetermined height, so that the slider 142 may slide along a predetermined direction. When a plurality of guide lines 177 is disposed on the inner surfaces facing each other, each of the guide lines 177 formed on the inner surfaces is formed substantially parallel to each other, to guide the sliders 142 and 143 without being distorted. The guide line 177 may be formed to have a plurality of lines, depending on the number of the slider 142. For example, when the slider 142 has N wheels, the guide line 177 is formed to have N-1 lines.

The guide bar 140 may have not only a cylindrical shape but also a polygonal shape, and may have a height corresponding to a distance between the side cover portions 174 and 175 facing each other. The slider 142 and 143 is fixed at least one end portion of the guide bar 140. For example, the slider 142 and 143 may have a plurality of wheels. Each of the wheels is connected with each other by a predetermined distance to be guided by the guide line 177. Alternatively, the slider 142 and 143 may include an element having low friction, so that the second monitor 120 may be easily moved.

A guide protrusion 144 is formed at a central portion of the guide bar 140 along the side cover portion having the opening. For example, as illustrated in FIG. 1, when the side cover portion 175 heading for the positive second direction +Y is open, the guide protrusion 144 is protruded along the positive second direction +Y.

The guide protrusion 144 preferably has the cylindrical shape, so that the first rotation part 150 rotates. A groove 145 is formed at a central portion of the guide protrusion 144, and is connected to a first connecting groove 152 of the first rotation part 150. Thus, the guide bar 140 and the first rotation part 150 are fixed to each other.

The first rotation part 150 has the cylindrical shape, and the first connecting groove 152 and a first connecting protrusion 154 are formed at a central portion of the first rotation part 150. The first connecting groove 152 has a shape corresponding to the protrusion of the guide protrusion 144, for the guide protrusion 144 to be inserted into the first connecting groove 152. For example, the first connecting groove preferably has a concave cylindrical shape, when the guide protrusion 144 has a convex cylindrical shape.

A groove 153 is formed at a central portion of the first connecting groove 152, and a center of the groove 153 formed at the first connecting groove 152 is aligned with that of the groove 145 formed at the guide protrusion 144. The groove 153 formed at the first connecting groove 152 and the groove 145 formed at the guide protrusion 144 are combined with each other by a first connecting pin 151. The first connecting pin 151 is combined with the grooves 153 and 145 by tight fit, so that the first rotation part 150 may be fixed to a predetermined position after rotating by a predetermined angle.

Thus, the guide protrusion 144 having the cylindrical shape and the first connecting groove 152 having the cylindrical shape corresponding to the shape of the guide protrusion 144 have substantially same rotation axis, and are fixed by the first connecting pin 151, so that the guide protrusion 144 and the first connecting groove 152 may rotate relative to each other with respect to the rotation axis.

A first connecting protrusion 154 is protruded substantially opposite direction to the first connecting groove 152. For example, as illustrated in FIG. 1, when the side cover portion 175 heading for the positive second direction +Y is open and the guide protrusion 144 is protruded along the positive second direction +Y, the first connecting protrusion 154 is protruded along the positive second direction +Y.

The first connecting protrusion 154 preferably has the cylindrical shape, for the second rotation part 160 to rotate. A groove 155 is formed at a central portion of the first connecting protrusion 154, and is connected with a second connecting groove 162 of the second rotation part 160. Thus, the first rotation part 150 and the second rotation part 160 are fixed to each other.

The second rotation part 160 has the cylindrical shape, and the second connecting groove 162 and a third connecting groove 164 are formed at a central portion of the second rotation part 160. The second connecting groove 162 has a shape corresponding to the protrusion of the first connecting protrusion 154, for the first connecting protrusion 154 to be inserted into the second connecting groove 162. For example, the second connecting groove 162 preferably has the concave cylindrical shape, when the first connecting protrusion 154 has the convex cylindrical shape.

A groove 163 is formed at the central portion of the second connecting groove 162, and a center of the groove 163 formed at the second connecting groove is aligned with that of the groove 155 formed at the first connecting protrusion 154. The groove 163 formed at the second connecting groove 162 and the groove 155 formed at the first connecting protrusion 154 are combined with each other by a second connecting pin 161. The second connecting pin 161 is combined with the grooves 163 and 155 by the tight fit, so that the second rotation part 160 may be fixed to a predetermined position after rotating by a predetermined angle.

Thus, the first connecting protrusion 154 having the cylindrical shape and the second connecting groove 162 having the cylindrical shape corresponding to the shape of the first connection protrusion 154 have substantially same rotation axis, and are fixed by the second connecting pin 161, so that the first connection protrusion 154 and the second connecting groove 162 may rotate relative to each other with respect to the rotation axis.

The third connecting groove 164 is protruded substantially opposite direction to the second connecting groove 162. For example, as illustrated in FIG. 1, when the side cover portion 175 heading for the positive second direction +Y is open, the guide protrusion 144 is protruded along the positive second direction +Y, and the first connecting protrusion 154 is protruded along the positive second direction +Y, the third connecting groove 164 is formed along the positive second direction +Y.

The monitor protrusion 123 formed at the central portion of the side surface of the second monitor 120 is inserted into the third connecting groove 164, so that the second rotation part 160 and the second monitor 120 are fixed to each other and rotate relative to each other. Particularly, a rotation axis of the second rotation part 160 and the second monitor 120 is substantially perpendicular to that of the first rotation part 150 and the second rotation part 160. For example, when the monitor protrusion 123 is protruded along the negative second direction −Y, the second monitor 120 and the second rotation part 160 rotate relative to each other with respect to the negative second direction −Y.

The third connecting pin 165 may be used between the monitor protrusion 123 and the third connecting groove 164, to enhance fixing force between the monitor protrusion 123 and the third connecting groove 164. The third connecting groove 164 and the monitor protrusion 123 are combined with each other by the tight fit as the combination between the guide protrusion 144 and the first connecting groove 152, and the combination between the first connecting protrusion 154 and the second connecting groove 162, so that the second monitor 120 may be fixed to a predetermined position after rotating by a predetermined angle. Thus, a viewing angle of the second screen 121 may be easily controlled.

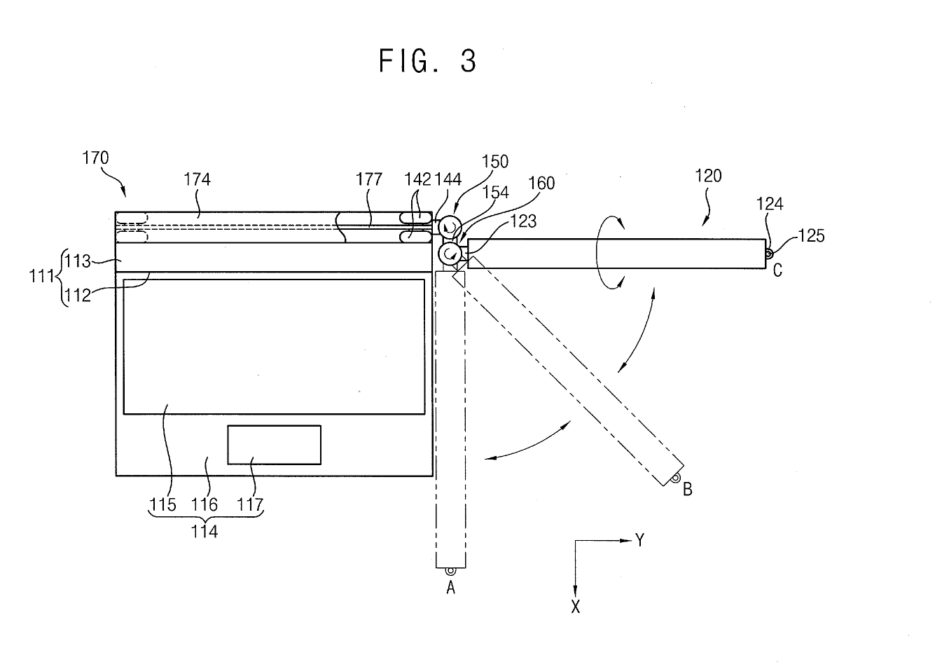

FIG. 3 is a plan view illustrating a movement of a connecting member according to an example embodiment of the dual monitor in FIG. 1.

Referring to FIG. 3, when the second monitor 120 is not used, the second monitor 120 is disposed and fixed inside of the cover portion of the guide fixing member 170. However, when the second monitor 120 is used, the second monitor 120 is fixed as follows.

First, the second monitor 120 moves along the positive second direction +Y to be disposed at one side portion of the first monitor 111. In this case, the guide bar 140 moves along the guide line 177, to be fixed to the end portion of guide fixing member 170 along the positive second direction +Y. The guide fixing member 170, the first rotation part 150, the second rotation part 160 and the second monitor 120 are aligned in a line along the second direction Y. In this case, the second monitor 120 may not be aligned with the first monitor 111 in the line, so that difference of the viewing angle between the first and second monitors 111 and 120 may be large.

Then, the first rotation part 150 rotates about 90° with respect to the first connecting pine 151, for example with respect to the positive third direction +Z. Thus, the second monitor 120 is disposed to have about 90° with respect to the first monitor 111 (position A). Then, the second rotation part 160 rotates about 90° with respect to the second connecting pin 161, for example with respect to the positive third direction +Z. Thus, the second monitor 120 is aligned with the first monitor 111 (position C). Then, the second rotation part 160 rotates with respect to the second connecting pin 161, so that the second monitor 120 may be positioned to have the optimal viewing angle (position B).

Alternatively, the second rotation part 160 may firstly rotate, and then the first rotation part 150 may rotate for the second monitor 120 to have the optimal viewing angle. In addition, the first and second rotation parts 150 and 160 may rotate at the same time.

Although not shown in the figure, the second monitor 120 may be protruded along the negative second direction −Y or the positive third direction +Z, and may move as mentioned above.

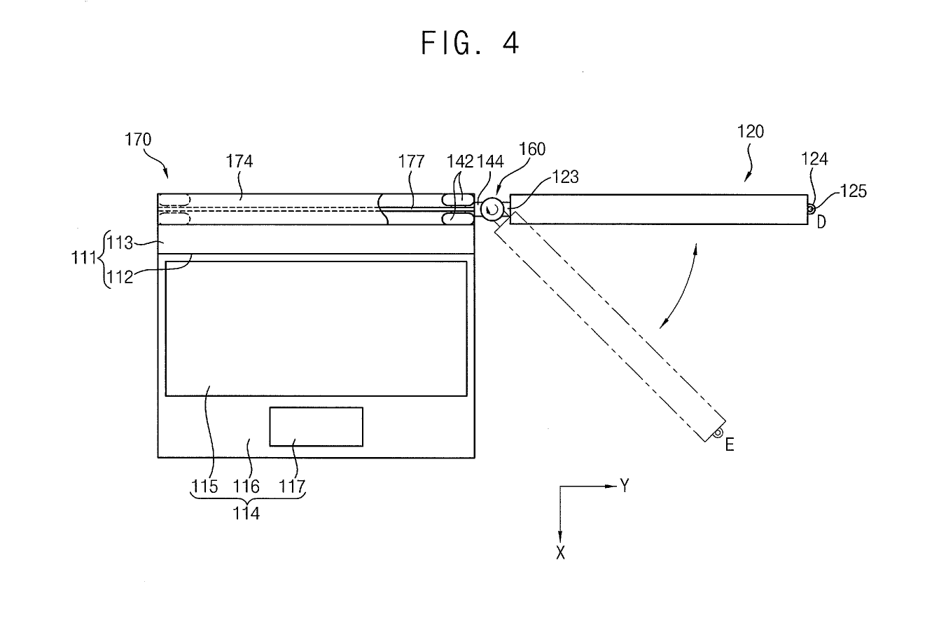

FIG. 4 is a plan view illustrating a movement of a connecting member 130 according to another example embodiment of the dual monitor.

Referring to FIG. 4, the connecting member 130 according to the present example embodiment includes the guide fixing member 170, the guide bar 140 and the second rotation part 160. Thus, the guide protrusion 144 is combined with the second connecting groove 162 of the second rotation part 160 through the second connecting pin 161. In addition, the monitor protrusion 123 is inserted into the third connecting groove 162 of the second rotation part 160. More detailed descriptions concerning the combinations between the above elements according to the present example embodiment are substantially same as the above mentioned example embodiment in FIG. 1, and thus any further repetitive explanation will be omitted.

In the present example embodiment, when the second monitor 120 is not used, the second monitor 120 is disposed and fixed inside of the cover portion of the guide fixing member 170. However, when the second monitor 120 is used, the second monitor 120 is fixed as follows.

First, the second monitor 120 moves along the positive second direction +Y to be disposed at one side portion of the first monitor 111. In this case, the guide bar 140 moves along the guide line 177, to be fixed to the end portion of the guide fixing member 170 along the positive second direction +Y. The guide fixing member 170, the first rotation part 150, the second rotation part 160 and the second monitor 120 are aligned in a line along the second direction Y (position D). In this case, the first and second monitors 111 and 120 are not aligned in the line, so that the difference of the viewing angle between the first and second monitors 111 and 120 may be large.

However, in the present example embodiment, the guide fixing member 170 and the second monitor 120 are connected with each other only through the second rotation part 160, so that the difference of the viewing angle between the first and second monitors 111 and 120 may not be precisely controlled. The second rotation part 160 rotates clockwise with respect to the second connecting pin 161, for example with respect to the positive third direction +Z by a predetermined angle, so that the second monitor 120 may be positioned to have the optimal viewing angle (position E).

In the present example embodiment, the connecting member 130 includes only one rotation part, so that the viewing angle may not be precisely controlled, the method for manufacturing the connecting member 130 may be more easily and costs for manufacturing the connecting member 130 may be decreased. In addition, the monitors are manufactured to have thinner thickness, so that a stepped portion between the first and second monitors 111 and 120 may be decreased, and thus the viewing angle may be enhanced.

In the dual monitor according the first example embodiment, when the second screen 121 of the second monitor 120 is fixed to the guide fixing member 170, the second screen 121 is fixed heading for substantially same direction as the first screen 112 of the first monitor 111. Alternatively, when the second screen 121 of the second monitor 120 is fixed to the guide fixing member 170, the second screen 121 is fixed heading for substantially opposite direction to the first screen 112 of the first monitor 111. For example, when the first screen 112 heads for a positive first direction +X, the second screen 121 may be fixed heading for a negative first direction −X.

Although the second screen 121 is fixed heading for substantially opposite direction to the first screen 112, when the second screen 121 is used, the second screen 121 rotates about 180° with respect to the third connecting pin 165, so that the second screen 121 may be positioned to head for substantially same direction as the first screen 112.

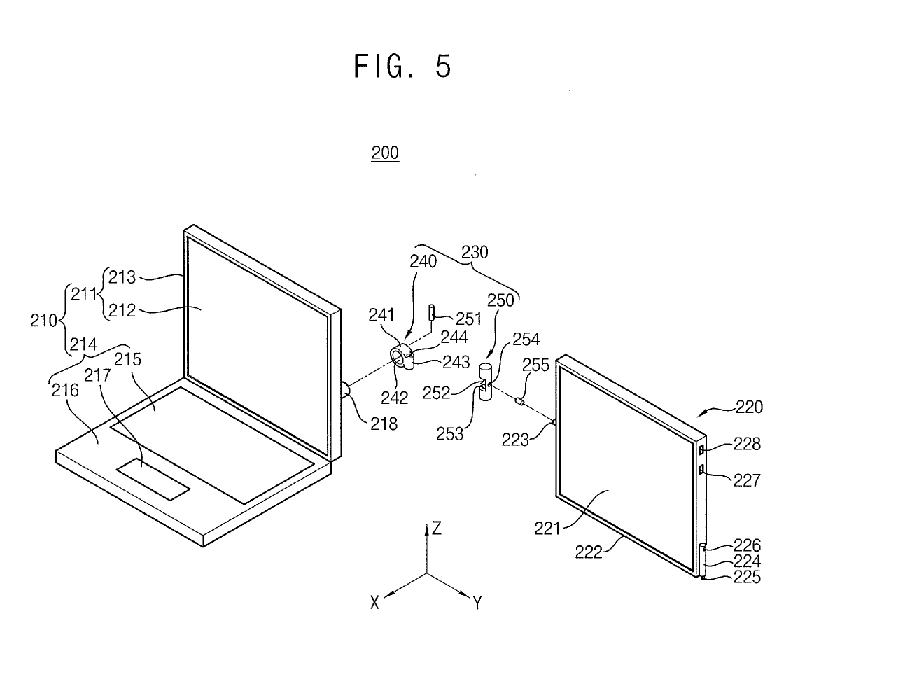

FIG. 5 is an enlarged perspective view illustrating a dual monitor 200 according to a second example embodiment of the present invention.

Referring to FIG. 5, the dual monitor 200 according to the present example embodiment includes a first monitor 211, a second monitor 220 and a connecting member 230.

The first monitor 211 according to the present example embodiment is substantially same as the first monitor 111 according to the first example embodiment except that the first monitor 211 includes a rear protrusion 218, and thus any further repetitive explanation concerning the element will be omitted. In addition, the second monitor 220 according to the present example embodiment is substantially same as the second monitor 120 according to the first example embodiment, and thus any further repetitive explanation concerning the element will be omitted.

The rear protrusion 218 is formed at a side central portion of a rear surface of the first monitor 211 on which the first monitor 211 is not disposed. For example, when the first screen 212 heads for the positive first direction +X, the rear protrusion 218 is protruded along the negative first direction −X. The rear protrusion 218 is inserted into a first connecting groove 242 of a first rotation part 240.

The connecting member 230 according to the present example embodiment includes the first rotation part 240 and a second rotation part 250.

The first rotation part 240 has the cylindrical shape having thin thickness. The first connecting groove 242 is formed at a central portion of the first rotation part 240, and a first connecting protrusion 243 is formed at a side portion of the first rotation part 240. The first connecting groove 242 has a diameter corresponding to that of the rear protrusion 218, so that the rear protrusion 218 is inserted into the first connecting groove 242. In addition, the first connecting groove 242 is formed at a central portion of the first rotation part 240 along substantially same direction as the rear protrusion 218. For example, when the rear protrusion 218 is formed along the negative direction −X, the first connecting groove 242 is formed along the first direction X.

The rear protrusion 218 and the first connecting groove 242 are combined with each other, and rotate relative to each other with respect to the rear protrusion 218. In this case, the rear protrusion 218 and the first connecting groove 242 are preferably combined by the tight fit, so that the first rotation part 240 is fixed to a predetermined position after rotating by a predetermined angle.

The first connecting protrusion 243 is protruded substantially perpendicular to the first connecting groove 242. For example, as illustrated in FIG. 5, when the first connecting groove 242 is formed along the first direction X, the first connecting protrusion 243 is protruded along the positive second direction +Y.

The combination between the first connecting protrusion 243 and the second rotation part 250 and the combination between the second rotation part 250 and the monitor protrusion 223 according to the present example embodiment are substantially same as that between the first connecting protrusion 154 and the second rotation part 160 and that between the second rotation part 160 and the monitor protrusion 123 according to the first example embodiment, and thus any further repetitive explanation concerning the above will be omitted.

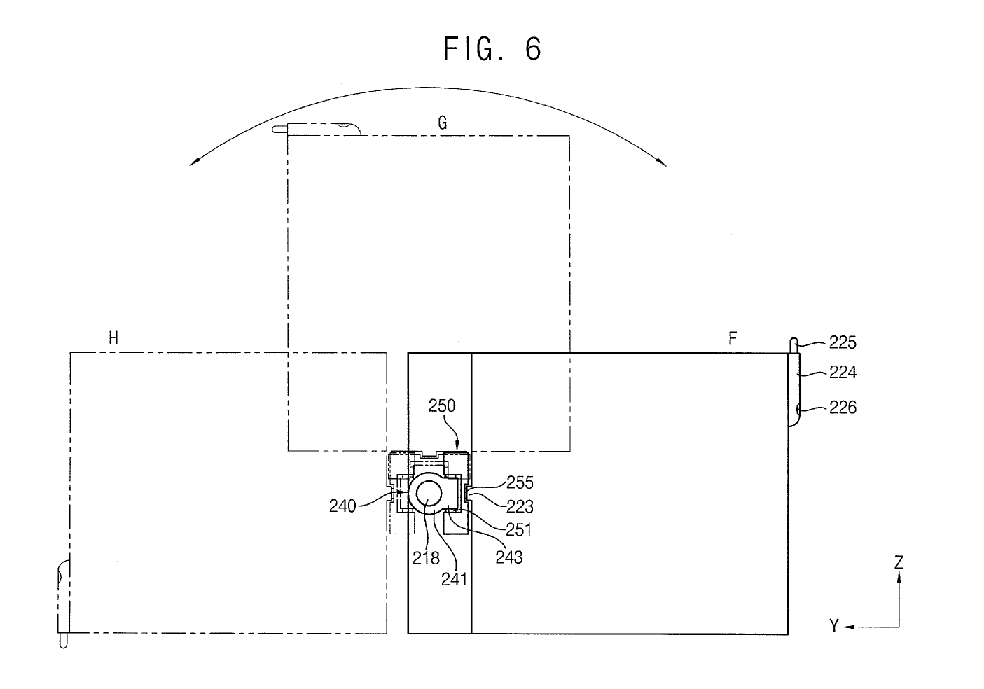

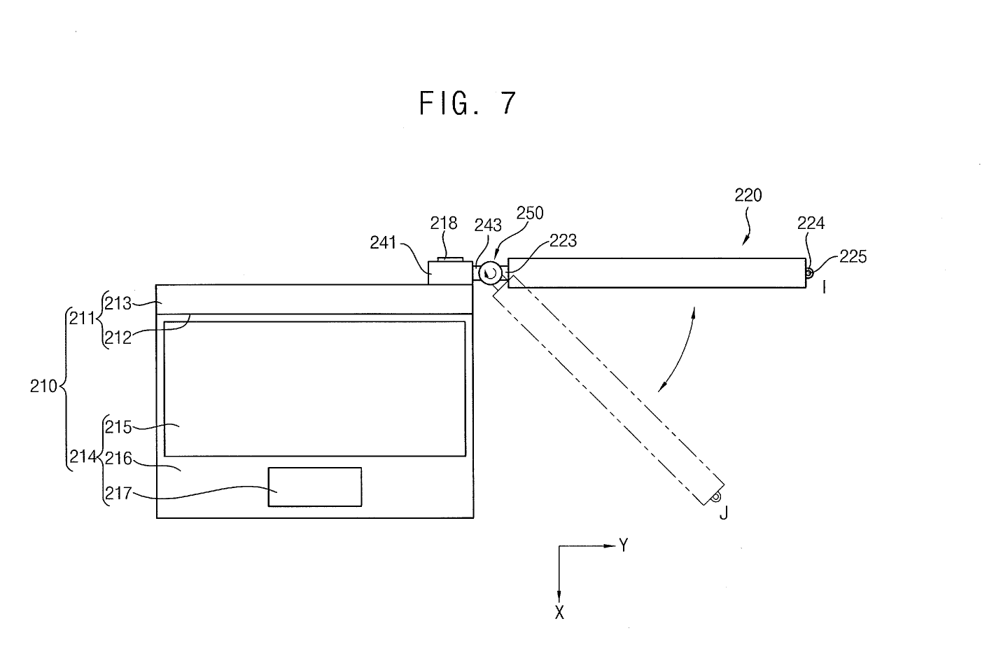

FIG. 6 is a plan view illustrating a movement of the first rotation part 240 of the dual monitor 200 in FIG. 5. FIG. 7 is a plan view illustrating a movement of the second rotation part 250 of the dual monitor 200 in FIG. 5.

Referring to FIGS. 6 and 7, when the second monitor 220 is not used, the second monitor 220 is fixed to the rear surface of the first monitor 211, for the second screen 221 to head for the rear surface of the first monitor 211 (position F). Although not shown in the figure, the first and second monitors 211 and 220 may include a fixing element formed at a predetermined position to be fixed to each other.

When the second monitor 220 is used, the second monitor 220 is fixed as follows.

First, the fixing element (not shown) is released, and the second monitor 220 rotates about 180° with respect to the rear protrusion 218 to be positioned to one side portion of the first monitor 211 (positions H and I). The second monitor 220 rotates counterclockwise with respect to the negative first direction −X in FIG. 6.

Alternatively, the second monitor 220 may rotate clockwise to be positioned to one side portion of the first monitor 211, according a position at which the rear protrusion 218 is formed. In this case, the second monitor 220 and the first monitor 211 are not aligned in a line, so that difference of the viewing angle between the first and second monitors 211 and 220 may be large.

After the second monitor 220 is positioned at one side portion of the first monitor 211, a fixing member 224 from a fixing member cover portion 225 is fixed to a ground, to fix the second monitor 220 to the ground. In this case, although not shown in the figure, an additional fixing element may be used, to tightly combine the rear protrusion 218 with the first connecting groove 242

In the present example embodiment, the first rotation part 240 and the second monitor 220 are connected with each other only through the second rotation part 250, so that the difference of the viewing angle between the first and second monitors 211 and 220 may not be precisely controlled. The second rotation part 250 rotates clockwise with respect to the first connecting pin 251, for example with respect to the positive third direction +Z by a predetermined angle, so that the second monitor 220 may be positioned to have the optimal viewing angle (position J).

In the present example embodiment, the connecting member 130 includes only one rotation part, so that the viewing angle may not be precisely controlled, the method for manufacturing the connecting member 130 may be more easily and costs for manufacturing the connecting member 130 may be decreased. In addition, the monitors are manufactured to have thinner thickness, so that a stepped portion between the first and second monitors 211 and 220 may be decreased, and thus the viewing angle may be enhanced. Alternatively, a third rotation part (not shown) is disposed between the first and second rotation parts 240 and 250, so that the viewing angle may be precisely controlled.

According to the present example embodiment, when the second screen 221 of the second monitor 220 is fixed on the rear surface of the first monitor 211, the second screen 221 is fixed substantially same direction as the first screen 212 of the first monitor 211. Alternatively, when the second screen 221 of the second monitor 220 is fixed on the rear surface of the first monitor 211, the second screen 221 may be fixed substantially opposite direction to the first screen 212 of the first monitor 211. For example, when the first screen 212 heads for the positive first direction +X, the second screen 221 may be fixed to head for the negative first direction −X.

Although the second screen 221 is fixed to head for substantially opposite direction to the first screen 212, when the second screen 221 is used, the second screen 221 rotates about 180° with respect to the second connecting pin 255, so that the second screen 221 may be positioned to head for substantially same direction as the first screen 212.

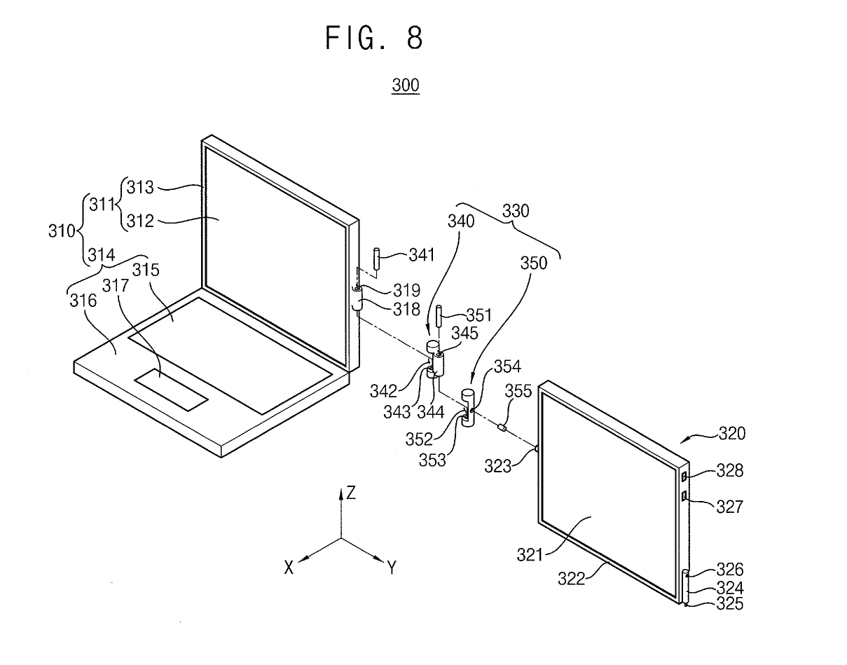

FIG. 8 is an enlarged perspective view illustrating a dual monitor 300 according to a third example embodiment of the present invention.

Referring to FIG. 8, the dual monitor 300 according to the present example embodiment includes a first monitor 311, a second monitor 320 and a connecting member 330.

The first monitor 311 according to the present example embodiment is substantially same as the first monitors 111 and 211 according to the first and second example embodiments except that the first monitor 311 includes a side protrusion 318, and thus any further repetitive explanation concerning the element will be omitted. In addition, the second monitor 320 according to the present example embodiment is substantially same as the second monitors 120 and 220 according to the first and second example embodiments, and thus any further repetitive explanation concerning the element will be omitted.

The side protrusion 318 is formed at a central portion of a side surface of the first monitor 311. For example, when the first screen 312 heads for the positive first direction +X, the side protrusion 318 is protruded along the positive second direction +Y. Alternatively, the side protrusion 318 may be protruded along the negative second direction −Y, and may be protruded along the positive third direction +Z. For example, the side protrusion 318 may be protruded along a direction for which the second monitor heads. The side protrusion 318 is inserted into a first connecting groove 342 of a first rotation part 340.

The connecting member 330 according to the present example embodiment includes the first rotation part 340 and a second rotation part 350.

The first rotation part 340 according to the present example embodiment has substantially same combination structures as the first rotation part 150 according to the first example embodiment except that the side protrusion 318 is inserted into the first connecting groove 342, and thus any further repetitive explanation will be omitted. In addition, the second rotation part 350 according to the present example embodiment has substantially same combination structures as the second rotation part 160 according to the first example embodiment, and thus any further repetitive explanation will be omitted.

The side protrusion 318 preferably has the cylindrical shape, so that the first rotation part 340 rotates. A groove 319 is formed at a central portion of the side protrusion 318, and is connected to the first connecting groove 342 of the first rotation part 340. A groove 343 is formed at a central portion of the first connecting groove 342. A center of the groove 319 formed at the side protrusion 318 is aligned with that of the groove 343 formed at the first connecting groove 342. The groove 319 formed at the side protrusion 318 is combined with the groove 343 formed at the first connecting groove 342 through a first connecting pin 341. The first connecting pin 341 is combined with the grooves 319 and 343 by the tight fit, so that the first rotation part 340 may be fixed to a predetermined position after rotating by a predetermined angle.

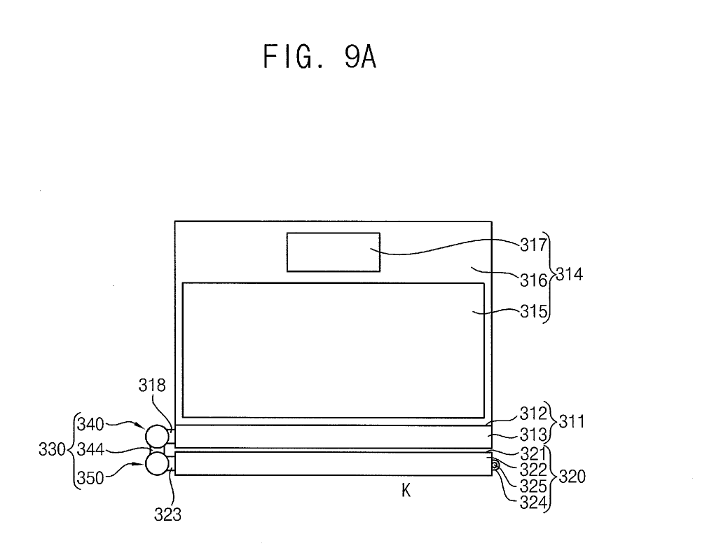

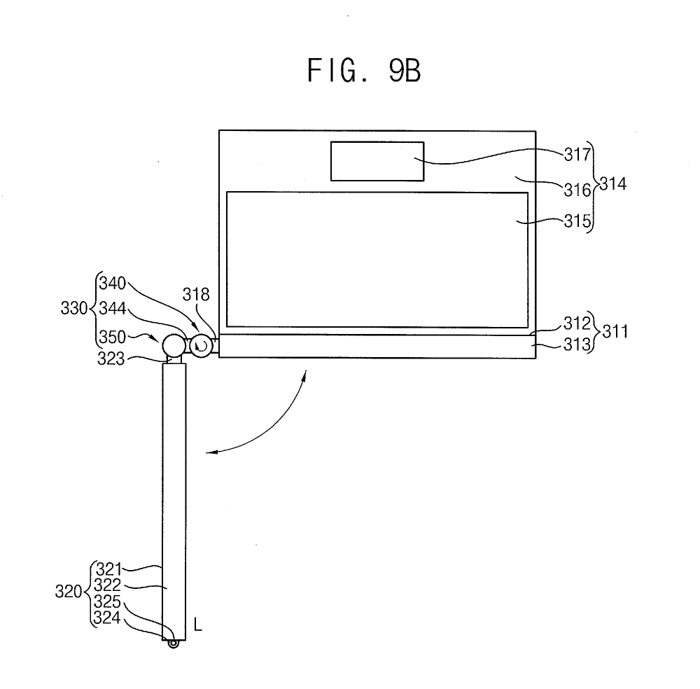

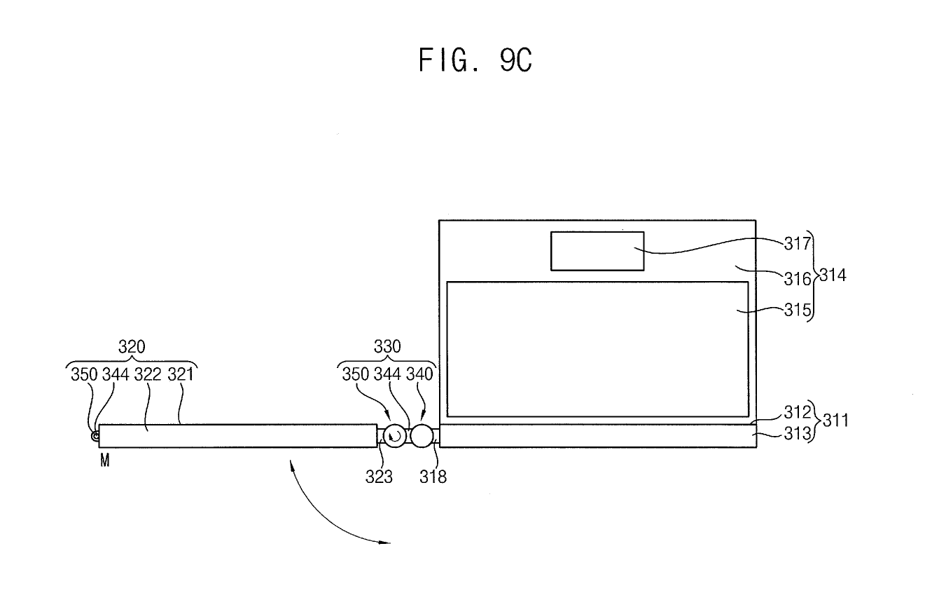

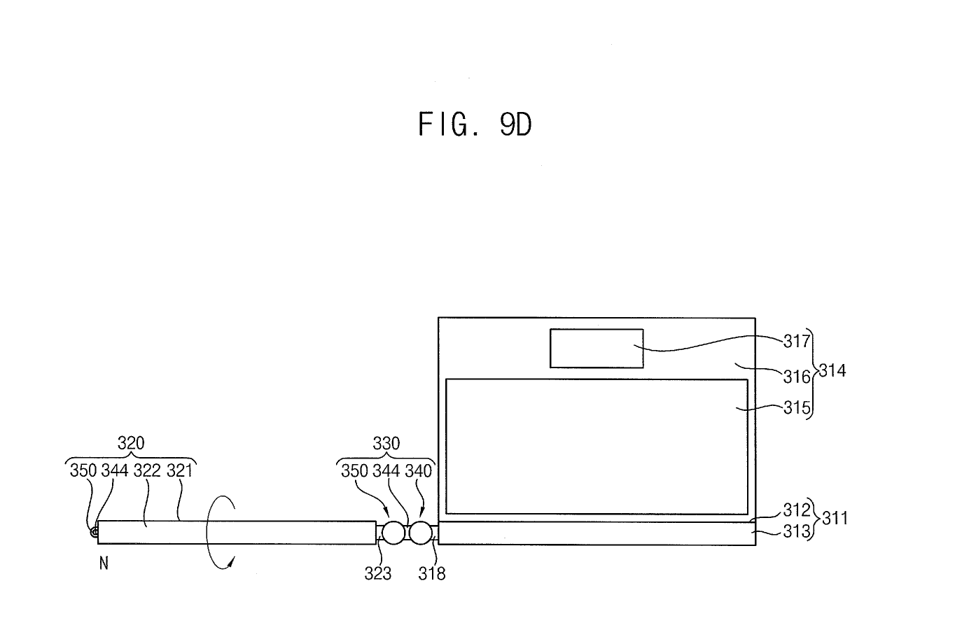

FIGS. 9A to 9D are plan views illustrating a movement of a connecting member 330 of the dual monitor 300 in FIG. 8.

Referring to FIGS. 9A to 9D, when the second monitor 320 is not used, the second monitor 320 is fixed for the second screen 321 to head for the rear surface of the first monitor 311 (position K). Although not shown in the figure, an additional fixing element may be disposed to tightly combine the first monitor 311 with the second monitor 320.

When the second monitor 320 is used, the second monitor 320 is fixed as follows.

First, the first rotation part 340 rotates clockwise about 90° with respect to the first connecting pin 341, for example with respect to the positive third direction +Z. Thus, the second monitor 320 is disposed to have about 90° with respect to the first monitor 311 (position L).

Then, the second rotation part 350 rotates clockwise about 90° with respect to a second connecting pin 351, for example with respect to the positive third direction +Z. Thus, the second monitor 320 is aligned with the first monitor 311 in a line (position M). In the position M, the second screen 321 of the second monitor 320 heads for the rear surface of the first monitor, for example the negative first direction −X.

Then, the second monitor 320 rotates about 180° with respect to a third connecting pin 355. Thus, the second screen 321 of the second monitor 320 is disposed to head for substantially same direction for which the first screen 312 of the first monitor 311 heads, for example the positive first direction +X (position N).

Then, the second rotation part 350 rotates with respect to the second connecting pin 351 by a predetermined angle, so that the second monitor 320 is positioned to have the optimal viewing angle.

Alternatively, after rotating the second rotation part 350, the first rotation part 340 rotates for the second monitor 320 to have the optimal viewing angle. In addition, the first and second rotation parts 340 and 350 may rotate at the same time, for the second monitor 320 to have the optimal viewing angle.

Although not shown in the figure, the second monitor 320 is protruded along the negative second direction −Y or the positive third direction +Z, to move mentioned above.

In the present example embodiment, when the second screen 321 of the second monitor 320 is fixed on the rear surface of the first monitor 311, the second screen 321 is fixed substantially same as the first screen 312 of the first monitor 311. Alternatively, when the second screen 321 of the second monitor 320 is fixed on the rear surface of the first monitor 311, the second screen 321 may be fixed substantially opposite to the first screen 312 of the first monitor 311. For example, when the first screen 315 heads for the positive first direction +X, the second screen may be fixed to head for the negative first direction.

Although the second screen 321 is fixed to head for substantially opposite direction to the first screen 312, when the second screen 321 is used, the second screen 321 rotates about 180° with respect to the third connecting pin 355. Thus, the second screen 321 is disposed to head for substantially same direction as the first screen 312.

According to the present invention, when the second monitor is not used, the first and second monitors are overlapped with each other to head for substantially same direction, so that the second screen may be protected without using additional protective elements.

In addition, when the second monitor is used, the second monitor is easily disposed near one side portion of the first monitor, to enhance efficiency of work.

In addition, the fixing member fixes the second monitor, so that the connecting member connecting the first monitor with the second monitor may be prevented from being bent or being damaged.

Having described the example embodiments of the present invention and its advantage, it is noted that various changes, substitutions and alterations can be made herein without departing from the spirit and scope of the invention as defined by appended claims.

What is claimed is:

1. A dual monitor comprising:
a first monitor including a first screen heading for a first direction;
a second monitor including a second screen heading for substantially same as the first direction for which the first screen heads, and being fixed on a rear surface of the first monitor on which the first screen is not disposed; and
a connecting member connecting the first monitor with the second monitor, and disposing the second monitor near one side portion of the first monitor when the second monitor is used.

2. The dual monitor of claim 1, wherein the connecting member comprises:
a guide fixing member fixed on the rear surface of the first monitor, and including a cover portion and a guide line, the cover portion having four side surfaces width of which corresponds to that of the second monitor and at least one of which is open for the second monitor to pass through, the guide line being disposed on an inner surface of the side surface perpendicular to the opened side surface to guide the second monitor; and
a guide bar including a slider that is disposed at least one end portion of the guide bar and is guided by the guide line, and a guide protrusion that is disposed at a central portion of the guide bar along a second direction substantially perpendicular to the first direction.

3. The dual monitor of claim 2, wherein the opened side surface heads for the second direction, and the side surface on which the guide line is disposed heads for a third direction substantially perpendicular to the first and second directions.

4. The dual monitor of claim 2, wherein the connecting member further comprises a first rotation part including:
a first connecting groove formed at a central portion of the first connecting groove into which the guide protrusion is inserted; and
a first connecting protrusion formed opposite to the first connecting groove.

5. The dual monitor of claim 4, wherein the guide protrusion and the first connecting groove are fixed with each other by a first connecting pin, and the first rotation part rotates with respect to the first connecting pin.

6. The dual monitor of claim 4, wherein the connecting member further comprises a second rotation part including:
a second connecting groove formed at a central portion of the second connecting groove into which the first connecting protrusion is inserted; and
a third connecting groove formed opposite to the second connecting groove.

7. The dual monitor of claim 6, wherein the first connecting protrusion and the second connecting groove are fixed with each other by a second connecting pin, and the second rotation part rotates with respect to the second connecting pin.

8. The dual monitor of claim 6, wherein the second monitor has a monitor protrusion that is formed at a central portion of a side surface of the second monitor to be inserted into the third connecting groove.

9. The dual monitor of claim 8, wherein the third connecting groove and the monitor protrusion are fixed with each other by a third connecting pin, and the second monitor rotates with respect to the third connecting pin.

10. The dual monitor of claim 2, wherein the connecting member further comprises a second rotation part including:
a second connecting groove formed at a central portion of the second connecting groove into which the guide protrusion is inserted; and
a third connecting groove formed opposite to the second connecting groove.

11. The dual monitor of claim 10, wherein the guide protrusion and the second connecting groove are fixed with each other by a second connecting pin, and the second rotation part rotates with respect to the second connecting pin.

12. The dual monitor of claim 10, wherein the second monitor has a monitor protrusion that is formed at a central portion of a side surface of the second monitor to be inserted into the third connecting groove.

13. The dual monitor of claim 12, wherein the third connecting groove and the monitor protrusion are fixed with each other by a third connecting pin, and the second monitor rotates with respect to the third connecting pin.

14. The dual monitor of claim 2, wherein the second monitor includes a fixing member formed at an edge of a rear surface of the second monitor on which the second screen is not disposed, to fix the second monitor to a ground.

15. A dual monitor comprising:
a first monitor including a first screen heading for a first direction;
a second monitor including a second screen heading for substantially opposite direction to the first direction for which the first screen heads and being fixed on a rear surface of the first monitor on which the first screen is not disposed, and rotating with respect to a protrusion formed on a side surface of the second monitor to head for substantially same as the first direction; and
a connecting member connecting the first monitor with the second monitor, and disposing the second monitor near one side portion of the first monitor when the second monitor is used.

16. The dual monitor of claim 15, wherein the connecting member comprises:
a guide fixing member fixed on the rear surface of the first monitor, and including a cover portion and a guide line, the cover portion having four side surfaces width of which corresponds to that of the second monitor and at least one of which is open for the second monitor to pass through, the guide line being disposed on an inner surface of the side surface perpendicular to the opened side surface to guide the second monitor; and
a guide bar including a slider that is disposed at least one end portion of the guide bar and is guided by the guide line, and a guide protrusion that is disposed at a central portion of the guide bar along a second direction substantially perpendicular to the first direction.

17. A dual monitor comprising:
a first monitor including a first screen heading for a first direction, and a rear protrusion formed at a side central portion of a rear surface of the first monitor on which the first screen is not disposed along substantially opposite direction to the first direction;
a second monitor including a second screen heading for substantially same as the first direction for which the first screen heads, and being fixed on the rear surface of the first monitor on which the first screen is not disposed; and
a connecting member connecting the first monitor with the second monitor, and disposing the second monitor near one side portion of the first monitor when the second monitor is used.

18. The dual monitor of claim 17, wherein the connecting member includes a first rotation part having a first connecting groove formed at a central portion of the first rotation part and a first connecting protrusion formed substantially perpendicular to the first connecting groove, the rear protrusion inserted into the first connecting groove.

19. The dual monitor of claim 18, wherein the first rotation part rotates with respect to the rear protrusion.

20. The dual monitor of claim 18, wherein the connecting member further includes a second rotation part having a second connecting groove formed at a central portion of the second rotation part and a third connecting groove formed along substantially opposite direction to the second connecting groove, the first connecting protrusion inserted into the second connecting groove.

21. The dual monitor of claim 20, wherein the first connecting protrusion and the second connecting groove are fixed to each other by a first connecting pin, and the second rotation part rotates with respect to the first connecting pin.

22. The dual monitor of claim 20, wherein the second monitor has a monitor protrusion formed at a central portion of a side surface of the second monitor and inserted into the third connecting groove.

23. The dual monitor of claim 22, wherein the third connecting groove and the monitor protrusion are fixed to each other by a second connecting pin, and the second connecting pin rotates with respect to the second connecting pin.

24. The dual monitor of claim 17, wherein the second monitor includes a fixing member formed at an edge of a rear surface of the second monitor on which the second screen is not disposed, to fix the second monitor to a ground.

25. A dual monitor comprising:
a first monitor including a first screen heading for a first direction, and a rear protrusion formed at a side central portion of a rear surface of the first monitor on which the first screen is not disposed along substantially opposite direction to the first direction;
a second monitor including a second screen heading for substantially opposite to the first direction for which the first screen heads and being fixed on the rear surface of the first monitor on which the first screen is not disposed, and rotating with respect to a protrusion formed on a side surface of the second monitor to head for substantially same as the first direction; and
a connecting member connecting the first monitor with the second monitor, and disposing the second monitor near one side portion of the first monitor when the second monitor is used.

26. The dual monitor of claim 25, wherein the connecting member includes a first rotation part having a first connecting groove formed at a central portion of the first rotation part and a first connecting protrusion formed substantially perpendicular to the first connecting groove, the rear protrusion inserted into the first connecting groove, and the first rotation part rotates with respect to the rear protrusion.

27. The dual monitor of claim 26, wherein the connecting member further includes a second rotation part having a second connecting groove formed at a central portion of the second rotation part and a third connecting groove formed along substantially opposite direction to the second connecting groove, the first connecting protrusion inserted into the second connecting groove, and wherein the first connecting protrusion and the second connecting groove are fixed to each other by a first connecting pin, and the second rotation part rotates with respect to the first connecting pin.

28. A dual monitor comprising:
a first monitor including a first screen heading for a first direction, and a side protrusion formed substantially perpendicular to the first direction at a central portion of a side surface of the first monitor;
a second monitor including a second screen heading for substantially same as the first direction for which the first screen heads, and being fixed on the rear surface of the first monitor on which the first screen is not disposed; and
a connecting member connecting the first monitor with the second monitor, and disposing the second monitor near one side portion of the first monitor when the second monitor is used.

29. The dual monitor of claim 28, wherein the connecting member includes a first rotation part having a first connecting groove formed at a central portion of the first rotation part and a first connecting protrusion formed along substantially opposite direction to the first connecting groove, the side protrusion inserted into the first connecting groove.

30. The dual monitor of claim 29, wherein the side protrusion and the first connecting groove are fixed to each other by a first connecting pin, and the first rotation part rotates with respect to the first connecting pin.

31. The dual monitor of claim 29, wherein the connecting member further includes a second rotation part having a second connecting groove formed at a central portion of the second rotation part and a third connecting groove formed along substantially opposite direction to the second connecting groove, the first connecting protrusion inserted into the second connecting groove.

32. The dual monitor of claim 31, wherein the first connecting protrusion and the second connecting groove are fixed to each other by a second connecting pin, and the second rotation part rotates with respect to the second connecting pin.

33. The dual monitor of claim 31, wherein the second monitor has a monitor protrusion formed at a central portion of a side surface of the second monitor and inserted into the third connecting groove.

34. The dual monitor of claim 33, wherein the third connecting groove and the monitor protrusion are fixed to each other by a third connecting pin, and the second monitor rotates with respect to the third connecting pin.

35. The dual monitor of claim 28, wherein the second monitor includes a fixing member formed at an edge of a rear surface of the second monitor on which the second screen is not disposed, to fix the second monitor to a ground.

36. A dual monitor comprising:
a first monitor including a first screen heading for a first direction, and a side protrusion formed substantially perpendicular to the first direction at a central portion of a side surface of the first monitor;
a second monitor including a second screen heading for substantially opposite direction to the first direction for which the first screen heads and being fixed on the rear surface of the first monitor on which the first screen is not disposed, and rotating with respect to a protrusion formed on a side surface of the second monitor to head for substantially same as the first direction; and
a connecting member connecting the first monitor with the second monitor, and disposing the second monitor near one side portion of the first monitor when the second monitor is used.

37. The dual monitor of claim 36, wherein the connecting member includes a first rotation part having a first connecting groove formed at a central portion of the first rotation part and a first connecting protrusion formed along substantially opposite direction to the first connecting groove, the side protrusion inserted into the first connecting groove, and wherein the side protrusion and the first connecting groove are fixed to each other by a first connecting pin, and the first rotation part rotates with respect to the first connecting pin.

38. The dual monitor of claim 37, wherein the connecting member further includes a second rotation part having a second connecting groove formed at a central portion of the second rotation part and a third connecting groove formed along substantially opposite direction to the second connecting groove, the first connecting protrusion inserted into the second connecting groove, and wherein the first connecting protrusion and the second connecting groove are fixed to each other by a second connecting pin, and the second rotation part rotates with respect to the second connecting pin.
